(19) United States
(12) Patent Application Publication
(10) Pub. No.: US 2026/0112170 A1
(43) Pub. Date: Apr. 23, 2026

(54) IMAGE ANALYSIS METHOD AND SURVEILLANCE APPARATUS

(71) Applicant: VIVOTEK Inc., New Taipei City (TW)

(72) Inventor: Cheng-Chieh Liu, New Taipei City (TW)

(73) Assignee: VIVOTEK Inc., New Taipei City (TW)

(21) Appl. No.: 19/353,603

(22) Filed: Oct. 8, 2025

(30) Foreign Application Priority Data
Oct. 21, 2024 (TW) 113139964

(51) Int. Cl. G06V 20/52; G06V 20/54

(52) U.S. Cl. CPC G06V 20/52; G06V 20/54

(57) ABSTRACT

An image analysis method is applied to a surveillance apparatus and includes an operation processor of the surveillance apparatus setting a first object bonding box within a surveillance image, the operation processor acquiring data of a candidate bonding box within the surveillance image via a first object threshold, the operation processor computing an intersection parameter of the first object bonding box and the candidate bonding box, and the operation processor deciding a first object decided threshold in accordance with the intersection parameter.

### BACKGROUND OF THE INVENTION

### 1. Field of the Invention

The present invention relates to an image analysis method and surveillance apparatus, and more particularly, to an image analysis method with an adaptive object detection function and a related surveillance apparatus.

### 2. Description of the Prior Art

Conventional image analysis method uses the same identification threshold to perform object identification and object analysis for different types of objects (such as the pedestrian, the motorcycle, and the car) in the entire surveillance image. Although the deep learning model or the machine learning model can acquire the acceptable object identification and analysis result, feature vectors of the plural objects are difficult to distinguish when different objects are overlapped. Please refer to FIG. 5. FIG. 5 is a diagram of the surveillance image applied by the conventional surveillance apparatus in prior art. When the first object (e.g., the motorcycle) is overlapped with the second object (e.g., the passenger) and the threshold for detecting the second object remains at the original preset threshold, the feature vector of the second object is difficult to distinguish due to image overlap of the second object and the first object, and the second object cannot be detected. If the threshold for detecting the second object is lowered from the original preset threshold for detecting the second object, the second object (e.g., the dashed box shown in the left of FIG. 5) may be detected in the object identification and analysis result, but other objects in the same image (e.g., the diagonal pattern of a utility pole) may be mistakenly identified as the second object (e.g., the dashed box shown in the right of FIG. 5).

Therefore, a conventional method of using one threshold to identify or analyze the overlapping objects may reduce an accuracy of the object identification and analysis result. Design of an image analysis method that can automatically adjust the identification threshold for diverse objects is an important issue in the related surveillance industry.

### SUMMARY OF THE INVENTION

The present invention provides an image analysis method with an adaptive object detection function and related surveillance apparatus for solving above drawbacks.

According to one embodiment, an image analysis method is applied to a surveillance apparatus and includes setting a first object bonding box within a surveillance image, acquiring data of a candidate bonding box within the surveillance image via a first object threshold, computing an intersection parameter of the first object bonding box and the candidate bonding box, and deciding a first object decided threshold in accordance with the intersection parameter.

According to another embodiment, a surveillance apparatus includes an operation processor adapted to set a first object bonding box within a surveillance image, acquire data of a candidate bonding box within the surveillance image via a first object threshold, compute an intersection parameter of the first object bonding box and the candidate bonding box, and decide a first object decided threshold in accordance with the intersection parameter.

The image analysis method and the surveillance apparatus of the present invention can utilize the third object threshold to define the first object bonding box within the surveillance image for detecting the first object (e.g., the motorcycle), and the first object bonding box may be optionally expanded to the expanded first object bonding box. Then, the first object threshold can be further utilized to acquire the data of the candidate bonding box within the expanded first object bonding box (or the first object bonding box) for detecting the second object (e.g., the passenger). In the meantime, the intersection parameter of the expanded first object bonding box (or the first object bonding box) and the candidate bonding box can be computed, and the intersection parameter can be used to decide how to convert the first object threshold into the first object decided threshold, and the first object decided threshold can be used to detect the second object (e.g., the passenger on the motorcycle).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a surveillance apparatus according to an embodiment of the present invention.

FIG. 2 is a flow chart of the image analysis method according to the embodiment of the present invention.

FIG. 3 is a diagram of a surveillance image applied for the surveillance apparatus according to the embodiment of the present invention.

FIG. 4 is a diagram of the surveillance image with several bonding boxes according to the embodiment of the present invention.

FIG. 5 is a diagram of the surveillance image applied by the conventional surveillance apparatus in prior art.

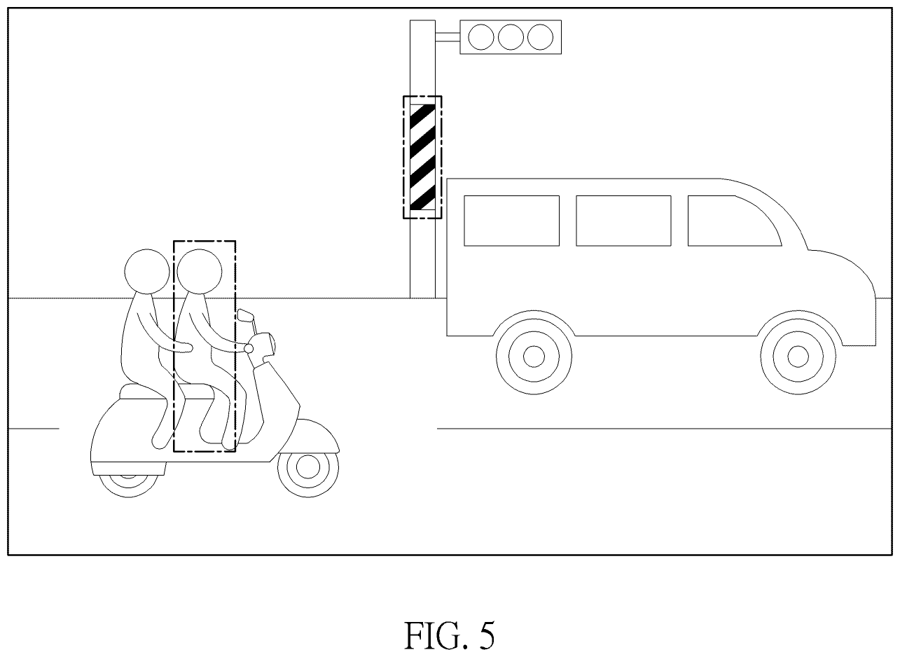

### DETAILED DESCRIPTION

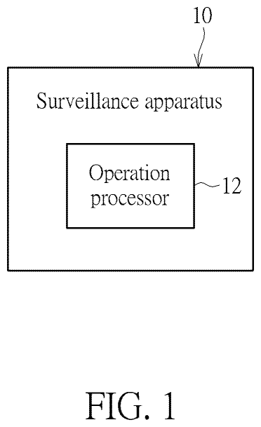

Please refer to FIG. 1. FIG. 1 is a functional block diagram of a surveillance apparatus 10 according to an embodiment of the present invention. The surveillance apparatus 10 can be an operation module disposed inside a surveillance camera, or can be a remote server electrically connected to the surveillance camera in a wired manner or in a wireless manner. In the preferred embodiment of the present invention, the surveillance apparatus 10 can be used to detect pedestrian or vehicle flow on the road, and utilize an operation processor 12 to execute an image analysis method of the present invention for detecting a second object (such as a motorcycle with two passengers) within an object bonding box (which is formed by a first object) and/or an adjacent area. Application of the surveillance apparatus 10 is not limited to the foresaid embodiment, and can depend on an actual demand. The surveillance apparatus 10 can detect the weapon (e.g., the second object) held by the person (e.g., the first object), or detect the person (e.g., the second object) stayed inside the vehicle (e.g., the first object), or detect the person (e.g., the second object) sat on the wheelchair (e.g., the first object).

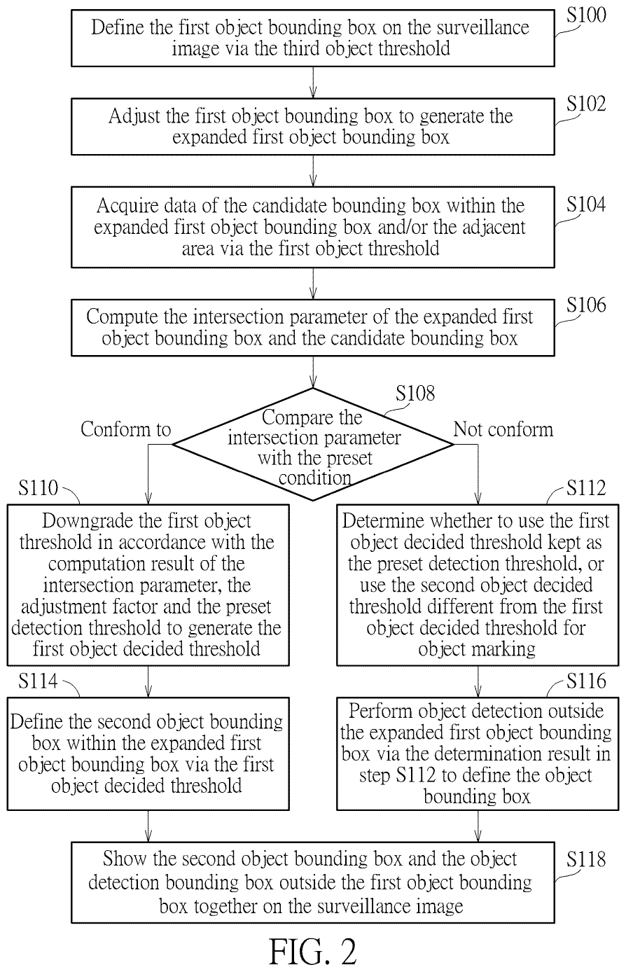

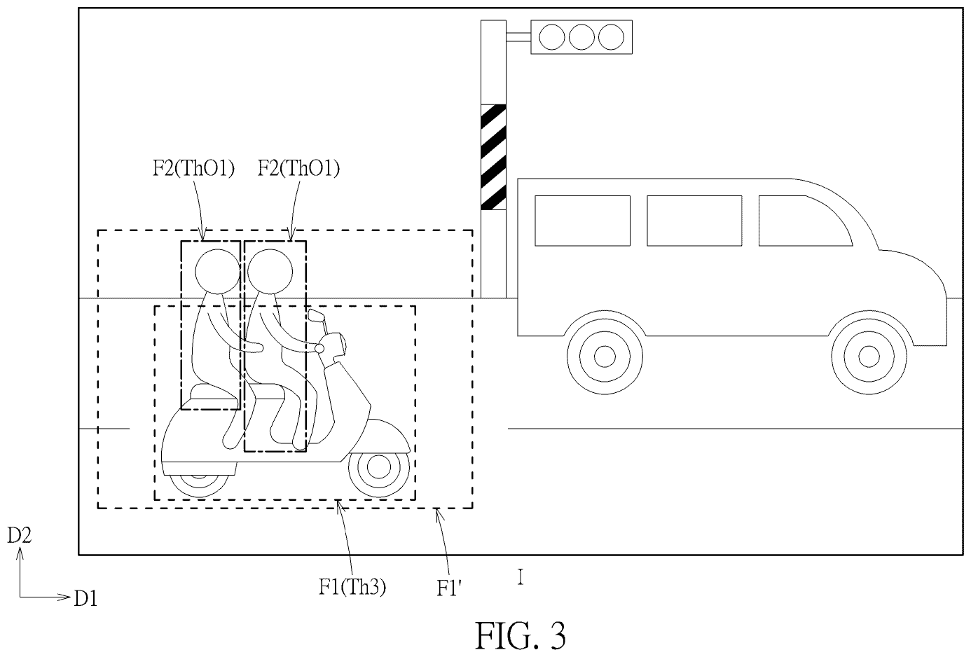

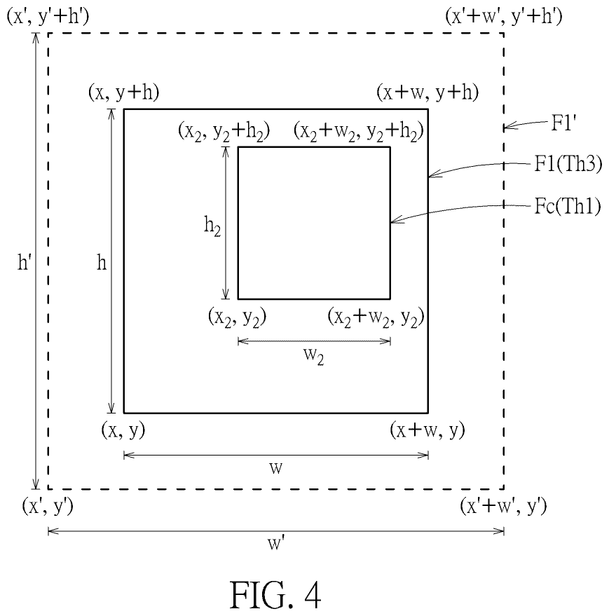

Please refer to FIG. 2 to FIG. 4. FIG. 2 is a flow chart of the image analysis method according to the embodiment of the present invention. FIG. 3 is a diagram of a surveillance image I applied for the surveillance apparatus 10 according to the embodiment of the present invention. FIG. 4 is a diagram of the surveillance image I with several bonding boxes according to the embodiment of the present invention. First, step S100 can be executed to acquire the surveillance image I and use object identification technology to define a first object bonding box F1 on the surveillance image I via a third object threshold Th3. The foresaid object identification technology can analyze the surveillance image I to generate a plurality of feature vectors via convolutional neural networks or deep learning networks (such as You Only Look Once, YOLO algorithm), and perform object detection on a target object via a third object threshold Th3, so as to define the first object bonding box F1 for the target object. In the embodiment, the surveillance apparatus 10 can detect two passengers sitting on the motorcycle (e.g., the target object), so that the third object threshold Th3 can be an identification threshold for the motorcycle (e.g., the first object), and the object identification technology using the third object threshold Th3 may not be able to perfectly classify the motorcycle (e.g., the first object) and the two passengers (e.g., the second objects) into the first object bonding box F1.

Therefore, step S102 can be optionally executed to expand the first object bonding box F1 for generating an expanded first object bonding box F1′. The image analysis method of the present invention can expand at least one of a height and a width of the first object bonding box F1 in accordance with an actual demand, so as to generate the expanded first object bonding box F1′. For example, if the first object bonding box F1 is a rectangle, step S102 may expand a left side and a right side, as well as an upper side and a lower side of the first object bonding box F1 along a preset direction (e.g., a horizontal direction D1 and a vertical direction D2) in a proportional or non-proportional manner; or, step S102 may expand one of the left side and the right side of the first object bonding box F1, and/or expand one of the upper side and the lower side of the first object bonding box F1. Variation of the frame expansion can depend on a design demand. Besides, the object bonding box is not limited to the rectangle, and can be designed as a closed shape of other shapes (such as a circle, an ellipse, or a polygon), and its variation can depend on the design demand.

Then, step S104 can be executed that the object identification technology is applied to acquire data of a candidate bonding box Fc within the surveillance image I, or within the first object bonding box F1 and/or the adjacent area, or within the expanded first object bonding box F1′ and/or the adjacent area via a first object threshold Th1. In the embodiment, the first object threshold Th1 can be the identification threshold for the passenger; however, the upper body of the passenger is much higher than the motorcycle, and position of the candidate bonding box Fc (which is used to mark the passenger) may be partly located outside the first object bonding box F1 (or the expanded first object bonding box F1′), so the object identification technology can utilize the first object threshold Th1 to acquire data of the candidate bonding box Fc within the first object bonding box F1 (or the expanded first object bonding box F1′) and/or the adjacent area.

It should be mentioned that step S104 may only acquire the data of the candidate bonding box Fc, and does not actually display the candidate bonding box Fc on the surveillance image I. In other words, a frame range of the candidate bonding box Fc is not shown in FIG. 3 for comparison with the first object bonding box F1 (or the expanded first object bonding box F1′). In addition, FIG. 4 shows coordinate change relationship between the first object bonding box F1, the expanded first object bonding box F1′ and the candidate bonding box Fc, and is not a conversion result of the embodiment shown in FIG. 3, so that relative positions between the first object bonding box F1 and the expanded first object bonding box F1′ are different in FIG. 3 and FIG. 4. Moreover, the first object threshold Th1 can be the identification threshold preferably for the passenger. If the candidate bonding box Fc is overlapped with the first object bonding box F1 (or the expanded first object bonding box F1′), accuracy of the image analysis method for identifying the passenger sitting on the motorcycle in a special situation of the surveillance image I may be affected, and subsequent steps are required to convert the first object threshold Th1 into a threshold value applicable for the special situation.

After that, step S106 can be executed to compute an intersection parameter of the first object bonding box F1 (or the expanded first object bonding box F1′) and the candidate bonding box Fc. The first example of step S106 can compute an overlapped area of the first object bonding box F1 (or the expanded first object bonding box F1′) and the candidate bonding box Fc and then set the overlapped area as the intersection parameter, as illustrated in Formula 1 to Formula 4. The symbol (x) and the symbol (y) can be indicated as coordinate values of one corner of the first object bonding box F1. The symbol (w) and the symbol (h) can be indicated as a width and a height of the first object bonding box F1. The symbol (x′) and the symbol (y′) can be indicated as coordinate values of one corner of the expanded first object bonding box F1′. The symbol (w′) and the symbol (h′) can be indicated as a width and a height of the expanded first object bonding box F1′. The symbol (x₂) and the symbol (y₂) can be indicated as coordinate values of one corner of the candidate bonding box Fc. The symbol (w₂) and the symbol (h₂) can be indicated as a width and a height of the candidate bonding box Fc. The symbol (Aᵢₙₜₑᵣ) can be indicated as the overlapped area (which can be set as the intersection parameter) of the expanded first object bonding box F1′ and the candidate bonding box Fc.

$$F 1 = ( x , y , w , h ) \qquad Formula 1$$

$$F {1}^{′} = ( {x}^{′} , {y}^{′} , {w}^{′} , {h}^{′} ) \qquad Formula 2$$

$$Fc = ( {x}_{2} , {y}_{2} , {w}_{2} , {h}_{2} ) \qquad Formula 3$$

$${A}_{inter} = max ( 0 , min ( {x}^{′} + {w}^{′} , {x}_{2} + {w}_{2} ) - max ( {x}^{′} , {x}_{2} ) ) \times max ( 0 , min ( {y}^{′} + {h}^{′} , {y}_{2} + {h}_{2} ) - max ( {y}^{′} , {y}_{2} ) ) \qquad Formula 4$$

The second example of step S106 can compute an overlapped ratio OR of the overlapped area (Aᵢₙₜₑᵣ) of the first object bonding box F1 (or the expanded first object bonding box F1′) and the candidate bonding box Fc to an area A2 of the candidate bonding box Fc, and set the overlapped ratio OR as the intersection parameter, as illustrated in Formula 1 to Formula 6.

$$A 2 = {w}_{2} \times {h}_{2} \qquad Formula 5$$

$$OR = \frac{{A}_{i n t e r}}{A 2} \qquad Formula 6$$

Then, step S108 can be executed to compare the intersection parameter with a preset condition, and decide whether to downgrade the first object threshold Th1. The preset condition can be defined as an overlapping state of the overlapped area Aᵢₙₜₑᵣ and the area A2. When the intersection parameter conforms to the preset condition, it indicates an intersection of the overlapped area Aᵢₙₜₑᵣ and the area A2, and the overlapped ratio OR is not equal to zero, so that step S110 can be executed to downgrade the first object threshold Th1 in accordance with a computation result of the intersection parameter, the adjustment factor that step S110 can be executed to downg_{default} for generating a first object decided threshold ThO1, as illustrated in Formula 7. The threshold can be significantly downgraded (such as being converted from the first object threshold Th1 to the first object decided threshold ThO1) to decrease identification sensitivity in response to the greater overlapped ratio OR.

When the intersection parameter does not conform to the preset condition, it indicates the overlapped area Aᵢₙₜₑᵣ and the area A2 have no intersection, and the overlapped ratio OR is equal to zero, so that step S112 can be executed to determine whether to use the first object decided threshold ThO1 that is acquired by keeping the first object threshold Th1 as the preset detection threshold T_{default} (as illustrated in Formula 8), or use the second object decided threshold (which is preferably greater than the preset detection threshold T_{default}) different from the first object decided threshold ThO1 for applying the object detection on the second object (e.g., the passenger). If the overlapped area Aᵢₙₜₑᵣ and the area A2 do not overlap, the threshold is not changed to maintain the original identification sensitivity. An adjustment factor d ThO1 for which is preferably greater than the preset detection threshold Tobj threshold T_{default} can be a preset identification threshold for passenger categories. The symbol (Tₘᵢₙ) can be a minimal identification threshold for the passenger categories.

$$ThO 1 = max ( {T}_{default} - γ \times OR , {T}_{min} ) \qquad Formula 7$$

$$ThO 1 = {T}_{default} \qquad Formula 8$$

When the first object decided threshold ThO1 is decided, the image analysis method of the present invention can execute step S114 to define a second object bonding box F2 within the first object bonding box F1 (or the expanded first object bonding box F1′) of the surveillance image I by using the first object decided threshold ThO1 that is generated by downgrading the first object threshold Th1 in step S110. Then, step S116 can be executed to perform the object detection for the second object (e.g., the passenger) outside the first object bonding box F1 (or the expanded first object bonding box F1′) via a determination result in step S112 for defining a corresponding object bonding box. Step S114 can use the first object decided threshold ThO1 adjusted by the image analysis method of the present invention to define the second object bonding box F2 for the motorcycle with two passengers in the special situation, thereby effectively increasing the identification accuracy of the passenger. Step S116 can perform the object detection on a region other than the motorcycle (which means outside the first object bonding box F1 or the expanded first object bonding box F1′) in the special situation, and the second object decided threshold can be the same as or different from the third object threshold Th3. Final, step S118 can be executed to show the second object bonding box F2 (which is generated in step S114) and the object detection bonding box (which is generated in step S116 and not shown in the figures) outside the first object bonding box F1 (or the expanded first object bonding box F1′) together on the surveillance image I.

In conclusion, the image analysis method and the surveillance apparatus of the present invention can utilize the third object threshold to define the first object bonding box within the surveillance image for detecting the first object (e.g., the motorcycle), and the first object bonding box may be optionally expanded to the expanded first object bonding box. Then, the first object threshold can be further utilized to acquire the data of the candidate bonding box within the expanded first object bonding box (or the first object bonding box) for detecting the second object (e.g., the passenger). In the meantime, the intersection parameter of the expanded first object bonding box (or the first object bonding box) and the candidate bonding box can be computed, and the intersection parameter can be used to decide how to convert the first object threshold into the first object decided threshold, and the first object decided threshold can be used to detect the second object (e.g., the passenger on the motorcycle). The application scenarios of the surveillance apparatus is not limited to the foresaid embodiments. For example, the image analysis method and the surveillance apparatus of the present invention may detect the weapon (e.g., the second object) held by the person (e.g., the first object), or detect the person (e.g., the second object) stayed inside the vehicle (e.g., the first object), or detect the person (e.g., the second object) sat on the wheelchair (e.g., the first object).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image analysis method applied to a surveillance apparatus, the image analysis method comprising:
an operation processor of the surveillance apparatus setting a first object bonding box within a surveillance image;
the operation processor acquiring data of a candidate bonding box within the surveillance image via a first object threshold;
the operation processor computing an intersection parameter of the first object bonding box and the candidate bonding box; and
the operation processor deciding a first object decided threshold in accordance with the intersection parameter.

2. The image analysis method of claim 1, further comprising:
the operation processor further acquiring the data of the candidate bonding box within the first object bonding box and/or an adjacent area of the surveillance image via the first object threshold.

3. The image analysis method of claim 1, further comprising:
the operation processor expanding the first object bonding box to generate an expanded first object bonding box;
the operation processor further acquiring the data of the candidate bonding box within the expanded first object bonding box and/or an adjacent area via the first object threshold; and
the operation processor utilizing the expanded first object bonding box and the candidate bonding box to acquire the intersection parameter.

4. The image analysis method of claim 3, further comprising:
the operation processor expanding the first object bonding box along at least one preset direction to generate the expanded first object bonding box.

5. The image analysis method of claim 1, further comprising:
the operation processor computing an overlapped area of the first object bonding box and the candidate bonding box to set as the intersection parameter.

6. The image analysis method of claim 1, further comprising:
the operation processor computing an overlapped ratio of an overlapped area of the first object bonding box and the candidate bonding box to an area of the candidate bonding box to set as the intersection parameter.

7. The image analysis method of claim 1, further comprising:
the operation processor downgrading the first object threshold in accordance with a computation result of the intersection parameter, an adjustment factor and a preset detection threshold when the intersection parameter conforms to a preset condition, so as to generate the first object decided threshold.

8. The image analysis method of claim 1, further comprising:
the operation processor keeping the first object threshold at a preset detection threshold to set as the first object decided threshold when the intersection parameter does not conform to a preset condition.

9. The image analysis method of claim 1, further comprising:
the operation processor performing object detection outside the first object bonding box by the first object decided threshold kept at a preset detection threshold, or by a second object decided threshold different from the first object decided threshold.

10. A surveillance apparatus comprising:
an operation processor adapted to set a first object bonding box within a surveillance image, acquire data of a candidate bonding box within the surveillance image via a first object threshold, compute an intersection parameter of the first object bonding box and the candidate bonding box, and decide a first object decided threshold in accordance with the intersection parameter.

11. The surveillance apparatus of claim 10, wherein the operation processor is adapted to further acquire the data of the candidate bonding box within the first object bonding box and/or an adjacent area of the surveillance image via the first object threshold.

12. The surveillance apparatus of claim 10, wherein the operation processor is adapted to further expand the first object bonding box for generating an expanded first object bonding box, acquire the data of the candidate bonding box within the expanded first object bonding box and/or an adjacent area via the first object threshold; and utilize the expanded first object bonding box and the candidate bonding box to acquire the intersection parameter.

13. The surveillance apparatus of claim 12, wherein the operation processor is adapted to further expand the first object bonding box along at least one preset direction to generate the expanded first object bonding box.

14. The surveillance apparatus of claim 10, wherein the operation processor is adapted to further compute an overlapped area of the first object bonding box and the candidate bonding box for setting as the intersection parameter.

15. The surveillance apparatus of claim 10, wherein the operation processor is adapted to further compute an overlapped ratio of an overlapped area of the first object bonding box and the candidate bonding box to an area of the candidate bonding box for setting as the intersection parameter.

16. The surveillance apparatus of claim 10, wherein the operation processor is adapted to further downgrade the first object threshold in accordance with a computation result of the intersection parameter, an adjustment factor and a preset detection threshold when the intersection parameter conforms to a preset condition, so as to generate the first object decided threshold.

17. The surveillance apparatus of claim 10, wherein the operation processor is adapted to further keep the first object threshold at a preset detection threshold for setting as the first object decided threshold when the intersection parameter does not conform to a preset condition.

18. The surveillance apparatus of claim 10, wherein the operation processor is adapted to further perform object detection outside the first object bonding box by the first object decided threshold kept at a preset detection threshold, or by a second object decided threshold different from the first object decided threshold.
